(19) United States
(12) Patent Application Publication
(10) Pub. No.: US 2012/0095373 A1
(43) Pub. Date: Apr. 19, 2012

(54) WALKING ASSISTANCE DEVICE

(75) Inventors: Takashi Hirata, Wako-shi (JP); Tetsuya Ido, Wako-shi (JP); Hideo Shimizu, Wako-shi (JP)

(73) Assignee: HONDA MOTOR CO., LTD., Tokyo (JP)

(21) Appl. No.: 13/240,168

(22) Filed: Sep. 22, 2011

(30) Foreign Application Priority Data
Oct. 13, 2010 (JP) 2010-230653

(51) Int. Cl. A61H 1/02

(52) U.S. Cl. 601/35

(57) ABSTRACT

A walking assistance device applies a walking assistance force from an electric motor to a femoral part of a user. The device comprises a communication unit and an operation switch enabling unit. The operation switch enabling unit disables an operation switch of the walking assistance device until the communication unit receives a signal from an external device even when a power switch is turned on, and enables the operation switch when the communication unit has received a signal from the external device while the power switch is turned on. Thus, unauthorized use of the walking assistance device is prevented, and operation of the walking assistance device is supervised with control parameters suited for the particular user. Also, the walking assistance device can be shared by a plurality of users, and each user can use the walking assistance device with pre-selected control parameters that optimally suit the particular user.

### TECHNICAL FIELD

The present invention relates to a walking assistance device configured to be worn on the person of the wearer to assist the movement of the lower limbs of the wearer by using the power of electric motors, and in particular to a walking assistance device that is configured to be used only by an authorized person and operated in a proper manner under all conditions.

### BACKGROUND OF THE INVENTION

Previously proposed walking assistance devices include a power generator such as an electric motor to apply a walking assistance force to a lower limb of a user for the purposes of assisting the walking movement of the user and/or rehabilitating the walking impairment of the user. See JP2006-320349A, JP2006-320350A, JP2007-152035A and JP2009-95645A.

Normally, a walking assistance device is required to be used under proper supervision. In rehabilitating a person with walking impediments in medical institutions, the various parameters of the walking assistance device has to be optimally managed, and the properly selected rehabilitation regimens have to be rigorously observed under the supervision of a physical therapist or a licensed practical nurse with the aim of maximizing the effects of rehabilitation. If the walking device is improperly used, a desired rehabilitation effect may not be achieved, and the user may be put into the risk of injuries. It is therefore desirable to permit the walking assistance device to be used only by authorized persons.

### BRIEF SUMMARY OF THE INVENTION

Based on such a recognition by the inventors, a primary object of the present invention is to provide a walking assistance device that can prevent an unauthorized use of the walking assistance device.

A second object of the present invention is to provide a walking assistance device that can be used only under the supervision of a properly appointed administrator, and can be operated with appropriate control parameters for each user.

A third object of the present invention is to provide a walking assistance device that can be shared by a plurality of users, and allows each user to use the walking assistance device with pre-selected control parameters that optimally suit the particular user.

According to the present invention, such objects can be accomplished by providing a walking assistance device configured to apply a walking assistance force produced by an electric motor to a femoral part of a user, comprising: a control unit for controlling an operation of the electric motor; a power switch for selectively supplying electric power to the control unit; an operation switch for forwarding a signal to the control unit to selectively drive the electric motor; a communication unit for receiving a signal from an external device; an operation switch enabling unit that disables the operation switch until the communication unit receives a signal from the external device even when the power switch is turned on, and enables the operation switch when the communication unit has received a signal from the external device while the power switch is turned on.

Even when the power switch is turned on, the walking assistance device cannot be operated unless a proper signal from the external device is received by the communication unit. Therefore, an unauthorized use of the walking assistance device can be prevented.

Preferably, the signal received from the external device by the communication unit includes control parameters, typically designated for each particular user, for operating the walking assistance device, and the control unit is configured to set the control parameters therein.

Thereby, not only the walking assistance device can be used only under the supervision of a properly appointed administrator who has the external device under his or her control, but also the walking assistance device can be operated with appropriate control parameters for each user. In particular, the walking assistance device can be shared by a plurality of users, and each user can use the walking assistance device with pre-selected control parameters that optimally suit the particular user.

According to a preferred embodiment of the present invention, the signal received from the external device by the communication unit includes identification information unique to the particular walking assistance device, and the communication unit is configured to respond to the signal received from the external device only when the identification information matches with that of the particular walking assistance device.

Thereby, even when a plurality of walking assistance devices are employed, the administrator or administrators are enabled to use the designated walking assistance devices without causing any confusion.

According to a certain aspect of the present invention, the communication unit comprises a wireless communication unit, and the external device comprises a terminal configured to establish a wireless communication link with the wireless communication unit.

According to another aspect of the present invention, the communication unit comprises an interface unit, and the external device comprises a removable storage medium adapted to be interfaced by the interface unit.

According to yet another aspect of the present invention, the communication unit comprises an IC card reader, and the external device comprises an IC card reader.

### BRIEF DESCRIPTION OF THE DRAWINGS

Now the present invention is described in the following with reference to the appended drawings, in which:

FIG. 1 is a perspective view of a walking assistance device embodying the present invention;

FIG. 2 is a simplified rear view of the walking assistance device;

FIG. 3 is a block diagram of the control system of the walking assistance device; and

FIGS. 4 and 5 show a flowchart of the control routine employed by the control unit shown in FIG. 3.

### DETAILED DESCRIPTION OF THE PREFERRED EMBODIMENTS

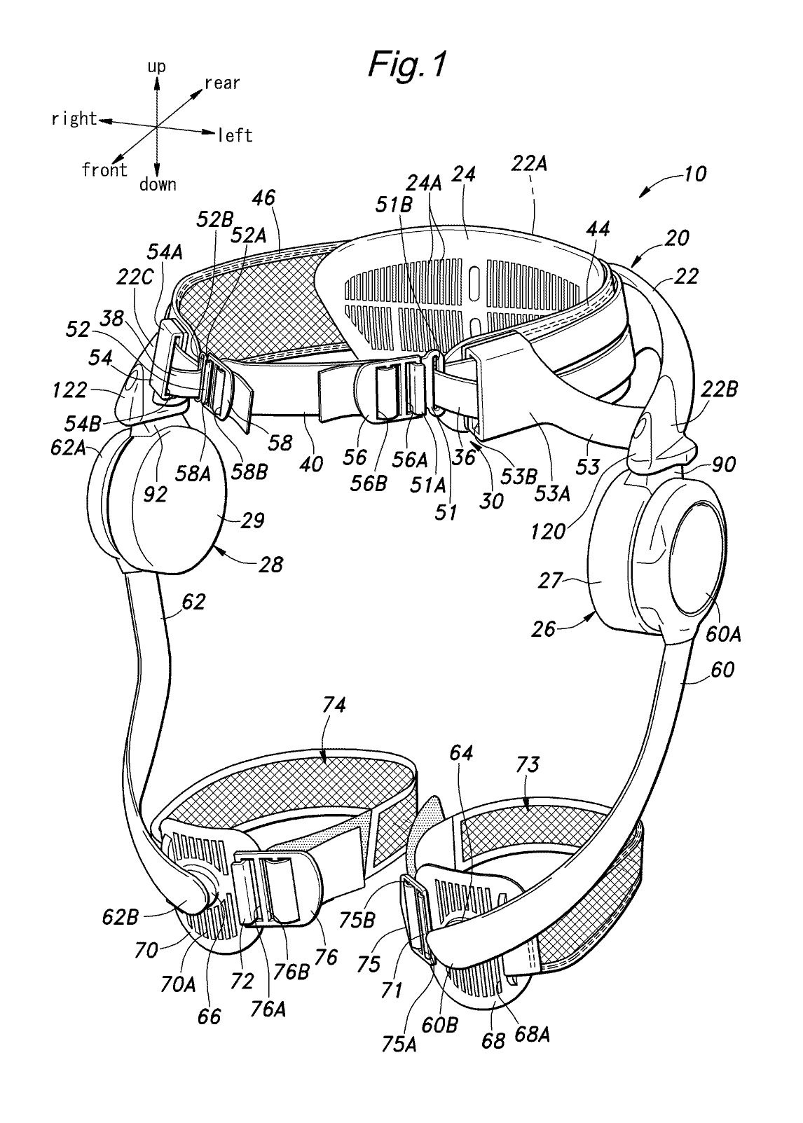

An embodiment of the walking assistance device of the present invention will now be described in the following with reference to FIGS. 1 to 5. The walking assistance device 10 is provided with a pelvic support assembly 20. The pelvic support assembly 20 is configured to be worn on the pelvic part of the user, and includes a main frame 22 that extends outwardly from a lower back part of the user to either side of the pelvic part to form a C-shape when viewed in plan view. The main frame 22 defines a hollow interior as will be described hereinafter, and is formed with molded plastic material such as polyamide resin, glass fiber reinforced plastic material, carbon fiber reinforced plastic material or other material having a high stiffness and mechanical strength.

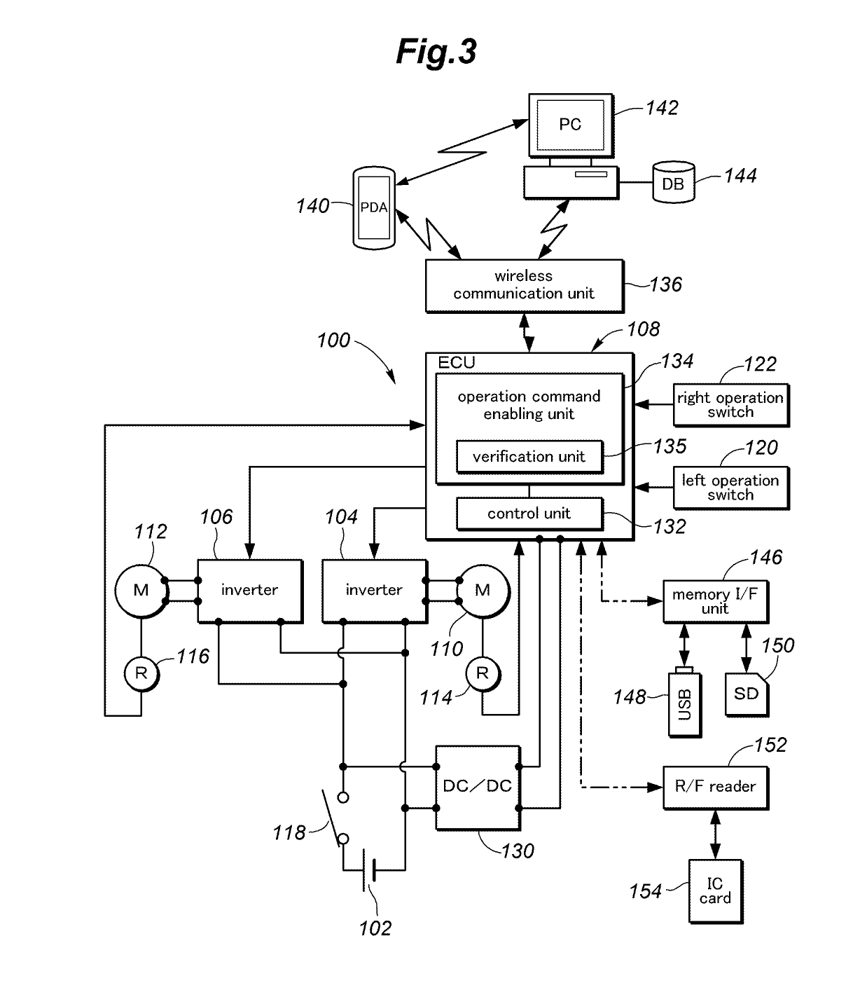

A left end part 22B and a right end part 22C on either side of the main frame 22 are positioned outwardly on either side of the user, and are each provided with a power generator mainly consisting of a motor unit 26, 28. Each motor unit 26, 28 is positioned so as to coincide with the corresponding hip joint of the user. The upper end of each motor unit 26, 28 is connected to the corresponding end part 22B, 22C of the main frame 22 via a hinge 90, 92 having a hinge axis extending in the coronal axis (front/back directional axis) of the user so that each motor unit 26, 28 is suspended from the upper end part thereof, and can rotate around the hinge axis within a prescribed angular range. Each motor unit 26, 28 is provided with an outer case 27, 29 which contains an electric motor 110, 112 (see FIG. 3) and an angular sensor (rotary encoder) 114, 116 for detecting an angular position of the output shaft of the corresponding electric motor 110, 112.

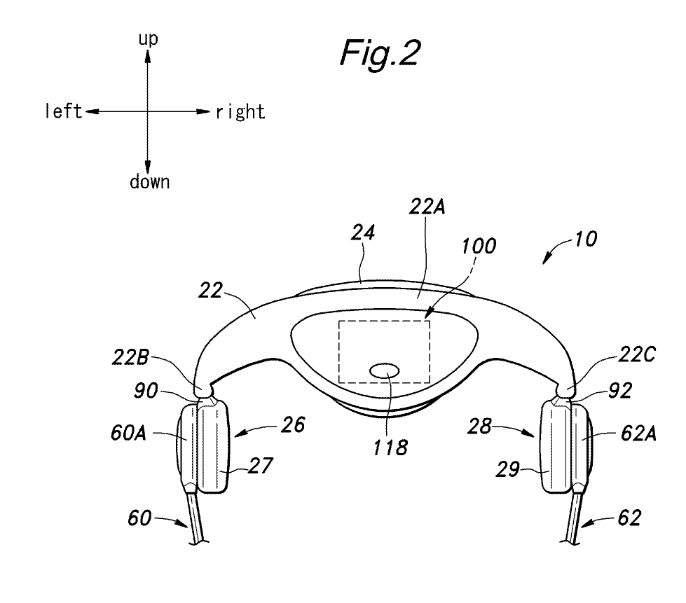

A middle part 22A of the main frame 22 is formed with a storage opening (FIG. 2) passed across the thickness thereof for receiving an electronic unit 100 including a pair of inverters 104 and 106 for driving the corresponding electric motors 110, 112, and an electronic control unit 108 (see FIG. 3).

A power switch 118 is provided on an outer surface of the back part of the middle part 22A of the main frame 22. The free end of the each end part 22B, 22C is provided with an operation switch 120, 122.

A back support member 24 is attached to the inner side of the middle part 22A of the main frame 22. The back support member 24 is made of a plastic plate member having a high resiliency, and is formed with a number of vertical slots 24A arranged laterally at a regular interval for promoting air permeability and enhancing resiliency with the aim of improving the comfort of the user.

Along the inner side of the main frame 22 extends an abdominal belt 30, which is wrapped around the abdominal part of the user. The abdominal belt 30 of this embodiment includes a left side belt 36, a right side belt 38 and a front belt 40. These belt parts 36, 38 and 40 are each made of flexible material such as fabric and leather.

The left side belt 36 is passed through an opening 51B of a left engagement piece 51, and the two ends of the left side belt 36 are attached to an upper and lower part of the inner side of the middle part 22A of the main frame 22, respectively, so as to form a loop. Therefore, the left side belt 36 is folded back in the shape of letter V at the left engagement piece 51. The length of the left side belt 36 can be adjusted by using a belt length adjustment buckle (not shown in the drawings) provided in a middle part of the belt. The left engagement piece 51 is made of plastic or metallic material, and is further provided with a left hook shaped part 51A at a free end thereof.

Similarly, the right side belt 38 is passed through an opening 52B of a right engagement piece 52, and the two ends of the right side belt 38 are attached to an upper and lower part of the inner side of the middle part 22A of the main frame 22, respectively, so as to form a loop. Therefore, the right side belt 38 is folded back in the shape of letter V at the right engagement piece 52. The length of the right side belt 38 can be adjusted by using a belt length adjustment buckle (not shown the drawings) provided in a middle part of the belt. The right engagement piece 52 is made of plastic or metallic material, and is further provided with a right hook shaped part 52A.

In the illustrated embodiment, each of the left and right engagement pieces 51 and 52 is made of a flat plate member having a slightly greater width than the belts 36 and 38.

Each end of the front belt 40 is fitted with a buckle 56, 58 provided with a rectangular opening 56A, 58A configured to receive the hook shaped part 51A, 52A of the corresponding engagement piece 51, 52. Each of the buckles 56, 58 is provided with a pair of rectangular openings 56B and 58B separated by a lateral bar for passing the corresponding end of the front belt 40 in a length adjustable manner. The left and right buckles 56 and 58 are each made of a flat plate member having a slightly greater width than the front belt 40.

Therefore, the front belt 40 can be detachably connected to the left and right side belts 36 and 38 by engaging the hook shaped parts 51A and 52A of the engagement pieces 51 and 52 with the openings 56A and 58A of the corresponding buckles 56 and 58. When the three parts of the abdominal belt 30 are connected to one another as described above, the abdominal belt 30 forms a loop that surrounds the abdominal part of the user. By suitably adjusting the length of each part of the abdominal belt 30 and snugly wrapping the abdominal belt 30 around the abdominal part of the user, the main frame 22 can be securely fitted to the pelvic part of the user without causing discomfort to the user.

The pelvic support assembly 20 further comprises a left supporter piece 44 and a right supporter piece 46. Each supporter piece 44, 46 is made of relatively stiff sheet member having a vertical width greater than the combined width of the two runs of the corresponding abdominal belt 36, 38 extending along the outer surface of the supporter piece 44, 46. Each supporter piece 44, 46 has a base end located between the back support member 24 and corresponding side belt 36, 38, and is jointly secured to the main frame 22, and extends along the inner surface of the side belt 36, 38. To impart a suitable stiffness to each supporter piece 44, 46, a resilient plastic or metallic wire may be incorporated in the supporter piece 44, 46, for instance, along the outer periphery thereof.

Thus, the supporter pieces 44 and 46 are flexible enough to conform to the contour of the pelvic part of the user but stiff enough to distribute the pressure from the left and right side belts 36 and 38 over a large area of the body of the user so that the comfort of the user may be enhanced. Also, in order to increase the air breathability, and ensure adequate comfort to the user in a warm weather, the supporter pieces 44 and 46 may be at least partly made of a mesh type fabric or other air permeable material.

The base end of the left supporter piece 44 is secured to the middle part 22A of the main frame 22, and extends between the back support member 24 and left abdominal belt 36 as mentioned earlier. The free end of the left supporter piece 44 terminates at a point adjacent to the left engagement piece 51 in the illustrated embodiment, but may also extend slightly beyond the left engagement piece 51.

Similarly, the base end of the right supporter piece 46 is secured to the middle part 22A of the main frame 22, and extends between the back support member 24 and right abdominal belt 38. The free end of the right supporter piece 46 terminates at a point adjacent to the right engagement piece 52 in the illustrated embodiment, but may also extend slightly beyond the left engagement piece 52. The right supporter piece 46 extends along the side of the user in a similar fashion as the left supporter piece 44.

A stabilizer member 53, 54 is connected to each end part 22B, 22C of the main frame 22. Each stabilizer member is made of an elongated, relatively stiff plastic member having a base end pivotally attached to the inner side of the corresponding end part 22B, 22C via a pivot member so as to be rotatable around a pivot axis substantially in parallel with the sagittal axis or so as to be rotatable in the vertical direction.

Each stabilizer member 53, 54 has a free end 53A, 54A formed with a passage 53B, 54B through which the two runs of the corresponding side belt 36, 38 are passed. The passage 53B, 54B has a certain length so that the stabilizer member 53, 54 may evenly engage a corresponding length of each run of the belt. The free end 53A, 54A of each stabilizer member 53, 54 is attached to a free end part of the corresponding supporter piece 44, 46 via a cushioning member such as a foamed plastic piece.

The stabilizer members 53 and 54 are made of a relatively stiff molded elastomeric material such as vulcanized rubber. The main part of each stabilizer member 53, 54 consists of a strip member having a relatively large width as compared to the thickness thereof and having a major plane extending along the outer contour of the abdominal part of the user. Therefore, the stabilizer members 53 and 54 are compliant in the direction to conform to the outer contour of the abdominal part of the user, but is relatively stiff against the bending deformation in the vertical direction.

As the abdominal belt 30 is fastened around the abdominal part of the user, and is tightened, the stabilizer members 53 and 54 deflect inwardly against the body of the user, and the free ends 53A and 54A thereof are placed adjacent to or slightly above the anterior superior iliac spine of the user.

To the output end of each electric motor unit 26, 28 on the exterior side thereof is releasably attached a base end part 60A, 62A of a swing arm 60, 62 in a torque transmitting relationship. Each swing arm 60, 62 is made of highly stiff and strong material such as aluminum, glass fiber reinforced plastic material, and carbon fiber reinforced plastic material. The main part of each swing arm 60, 62 consists of a hollow member having an elliptic cross section. The cross section of each swing arm 60, 62 is highly elongated along a major plane extending perpendicularly to the sagittal axial at the base end 60A, 62A thereof. Each swing arm 60, 62 is generally twisted so that the major plane of the free end 60B, 62B, which is located adjacent to a lower end of the femoral part, extends perpendicularly to the coronal axis.

The free end 60B, 62B of each swing arm 60, 62 is fitted with a front femoral support member 68, 70 via a coupling 64, 66 that permits angular movement of the femoral support member 68, 70 relative to the free end 60B, 62B of the swing arm 60, 62. Each front femoral support member 68, 70 is formed of a substantially rectangular plate member made of plastic material, and is curved so as to define a part-cylindrical surface that conforms to the outer contour of the lower femoral part of the user. Each front femoral support member 68, 70 is formed with a number of vertical slots 68A, 70A arranged laterally at a regular interval for promoting air permeability and enhancing resiliency with the aim of improving the comfort of the user.

A base end of a femoral belt 73, 74 is connected to a lateral edge of each femoral support member 68, 70, and a free end of the femoral belt 73, 74 is connected to a ladder shaped engagement member 75, 76. Each engagement member 75, 76 includes a belt length adjustment buckle 75B, 76B at the base end thereof for engaging the free end of the femoral belt 73, 74 in an adjustable manner, and a rectangular opening 75A, 75B formed on the free end thereof. A hook shaped feature 71, 72 is formed on the opposite lateral edge of the each femoral support member 68, 70 such that each hook shaped feature 71, 72 may be engaged by the rectangular opening 75A, 75B of the corresponding engagement member 75, 76. As shown in FIG. 1, the two femoral support assemblies are mirror images of each other.

This walking assistance device 10 can be worn by the user as described in the following. While the main frame 22 is placed on the back of the user either by himself or with the aid of a caretaker with the motor units 26 and 28 detached from the main frame 22, the abdominal belt 30 is passed around the pelvic part of the user, and is fastened by using the engagement pieces 51 and 52. The tension of the abdominal belt 30 may be adjusted by using the buckles 56 and 58. This can be accomplished with relative ease because of the absence of any heavy burden such as the motor units 26 and 28.

The motor units 26 and 28 are thereafter attached to the corresponding ends of the main frame by using the detachable arrangement for the motor units 26 and 28. Each femoral support member 68, 70 is worn on the front part of the corresponding femoral part of the user, and the femoral belt 73, 74 is passed along the back part of the femoral part of the user. The free end of the femoral belt 73, 74 is fastened to the femoral support member 68, 70 by engaging the rectangular opening 75A, 76A of the engagement member 75, 76 with the hook shaped feature 71, 72 of the femoral support member 68, 70.

As the user walks, the swing arms 60 and 62 are caused to undergo a swinging movement around the base ends 60A and 62A thereof. This angular movement is detected by the angular sensors 114, 116 incorporated in the motor units 26 and 28, and the control unit 100 drives the electric motors 110, 112 so as to provide an optimum assisting force to the femoral part of the user.

Referring to FIG. 3, the electronic control unit (ECU) 108 essentially consists of a microcomputer incorporated with an appropriate computer program. The ECU 108 receives electric power from a rechargeable battery 102, which also supplies power to the electric motors 110 and 112, via a DC/DC converter 130. The power switch 118 controls the supply of electric power to the ECU 108 and the inverters 104 and 106. The operation switches 120 and 122 are connected to the ECU 108 so that the electric motors 110 and 112 may be powered up and powered down by pressing either one of the operation switches 120, 122. To facilitate the use of the walking assistance device 10, the starting and stopping the operation of the walking assistance device 10 can be commanded by pressing either one of the operation switches 120, 122 provided on either side of the user.

The ECU 108 includes a control unit 132 for controlling the operation of the electric motors 110 and 112 in performing the walking assistance action. The control unit 132 is incorporated with flash memory for storing various control parameters associated with the walking assistance action such as the angular positions and angular speeds of the swing arms 60 and 62 in a re-writable manner, and performs a feedback control of the angular positions of the swing arms 60 and 62 according to the angular information provided by the angular sensors 114 and 116. Therefore, the ECU 108 forwards inverter command signals corresponding to the angular position commands for the electric motors 110 and 112 to the inverters 104 and 106 for the corresponding electric motors 110 and 112.

A wireless communication unit 136 is connected to the ECU 108 as a means for receiving external signals. The ECU 108 is incorporated with an operation command enabling unit 134 which is implemented by software as a means for enabling a switch command. The operation command enabling unit 134 keeps the operation switches 120 and 122 disabled even after the power switch 118 is turned on until the wireless communication unit 136 receives a signal from a portable information terminal such as a PDA 140 which may consist of any external terminal having a capability to communicate with the wireless communication unit 136. Once the wireless communication unit 136 receives a designated signal from the PDA 140, the ECU 108 enables the operation switches 120 and 122.

In the illustrated embodiment, the signal transmitted from the PDA 140 to the wireless communication unit 136 has to include unique identification information on the particular walking assistance device 10 for the signal to be effective in enabling the operation switches 120 and 122. The operation command enabling unit 134 includes a verification unit 135 configured to determine the authenticity of the unique identification information included in the signal.

More specifically, the verification unit 135 compares the identification information received from the PDA 140 with the identification information registered or stored in the verification unit 135, and maintains the disabled state of the operation switches 120 and 122 when a proper matching of the identification information is not achieved. On the other hand, when a proper matching is achieved, the verification unit 135 enables the operation switches 120 and 122, and maintains the enabled state until the power switch 118 is turned off.

The signal received from the PDA 140 by the wireless communication unit 136 includes control parameters that can be used by the control unit 132 to rewrite the currently internally stored control parameters with the newly received control parameters and control the walking assistance device in a corresponding manner.

The PDA 140 is managed by a designated administrator, and stores various control parameters of the walking assistance device such as the rotational angle and angular speed of the swing arms 60 and 62 for each user (patient). The PDA 140 is also provided with an editing function that allows the administrator to make changes to the control parameters of the existing users and create control parameters for new users by using a parameter editing display provided on the PDA 140. Typically, by simply selecting a user on the display of the PDA 140, the control parameters of the selected user are transmitted to the wireless communication unit 136.

The PDA 140 may be configured to communicate with a personal computer (PC) 142 via a wireless link, and download and upload the control parameters of users from and onto a database 144 incorporated in the PC 142. The PDA 140 may also receive control parameters from an external storage device such as USB memory 148 and SD memory 150.

The administrator who manages the PDA 140 typically consists a physical therapist or a licensed practical nurse who is in charge of supervising the use of the walking assistance device 10 in a medical institution specialized in walking rehabilitation.

The wireless communication unit 136 may also exchange control parameters and identification information of each user directly with the personal computer 140 equipped with the database 144 and is placed under the control of the administrator.

In the walking assistance device 10 incorporated with the above described structure, because the operation switches 120 and 122 are kept disabled, and the walking assistance device 10 does not operate unless the power switch 118 is turned on, and, additionally, the wireless communication unit 136 has received the prescribed signal from the PDA 140 or the PC 142, the use of the walking assistance device 10 by an unauthorized user can be avoided. Therefore, the theft of the walking assistance device is discouraged, and the improper use of the walking assistance device without the supervision of the administrator can be avoided. Also, because the walking assistance device is allowed to be used only by authorized users, and the walking assistance device is operated with the control parameters designated for each particular user, the improper use of the walking assistance device can be avoided, and the prescribed rehabilitation regimens can be offered in each case without fail so that the safety and effectiveness of the walking assistance device are enhanced owing to this personal verification and identification arrangement.

Also, the operation switches 120 and 122 are kept disabled even when the power switch 118 is turned on until the control unit 132 is supplied with the control parameters by receiving the designated signal from the PDA 140 or PC 142. Thereby, the walking assistance device 10 can be used only under the supervision of the administrator, and the proper control parameters are selected for the particular user without fail. Therefore, the improper use of the walking assistance device can be avoided, and a single walking assistance device can be shared by a plurality of users by using the proper control parameters designated for each particular user.

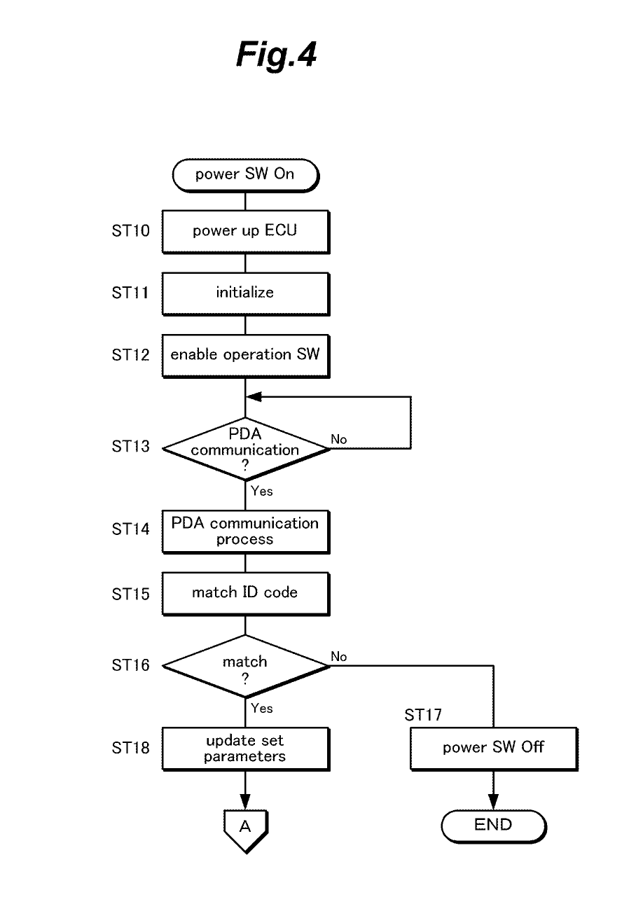

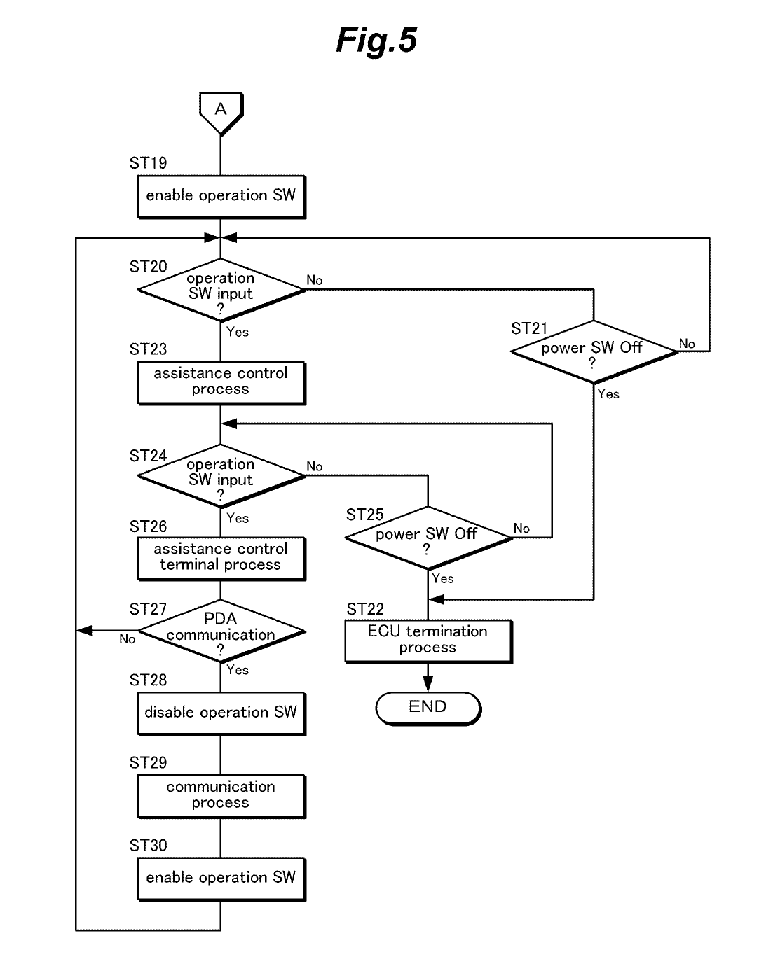

The control routine of the walking assistance device is described in the following with reference to the flowchart shown in FIGS. 4 and 5.

The ECU 108 is powered up, and the control routine is initiated (step ST10) when the power switch 118 is turned on. The ECU 108 then performs an initialization process that includes the clearing of the control parameters stored therein (step ST11).

The ECU 108 disables the operation switches 120 and 122 (step ST12), and waits for a signal from the PDA 140 (step ST13). The disabled state of the operation switches 120 and 122 is maintained until a designated signal is received from the PDA 140. When the operation switches 120 and 122 are disabled, the electric motors 110 and 112 cannot be activated by using the operation switches 120 and 122, and the walking assistance device 10 is therefore unable to provide any walking assistance force.

When a signal transmission is initiated in the PDA 140 (Yes in step ST13), a communication process for receiving a signal from the PDA 140 is performed (step ST14), and an ID code contained in the signal received from the PDA 140 is compared with the ID code stored in the verification unit 135 as individual identification information (step ST15).

When no match of the ID code is achieved (No in step ST16), the disabled state of the operation switches 120 and 122 is maintained, and the power switch 118 is forced to the off state (step ST17).

When a match of the ID code is achieved (Yes in step ST16), the control parameters received from the PDA 140 are written into the memory of the control unit 132 or the control parameters are updated (step ST18). The memory of the control unit 132 may consist of such memory as flash memory and RAM equipped with a power source, that does not lose the data even when the power is turned off.

Once the control parameters are set, the operation switches 120 and 122 are enabled (step ST19), and the ECU 108 waits for an input signal to be forwarded from the operation switches 120 and 122 (step ST20). In absence of an input or a command from either one of the operation switches 120 and 122, it is determined if the power switch 118 is turned off (ST21). When the power switch 118 is still on, the program flow returns to step ST20. When the power switch 118 is turned off, the ECU 108 performs a termination process, and shuts off the power (step ST22) before ending the control routine.

When at least one of the operation switches 120 and 122 is operated by the user at this time (Yes in step ST20), a walking assistance control is executed by using the control parameters set in the control unit 132 (step ST23).

During the time the walking assistance control is in progress, as long as neither one of the operation switches 120 and 122 is operated (No in step ST24), the program flow advances to step ST25 to determine if the power switch 118 is turned off. If the power switch 118 is turned off at this time, the ECU 108 performs a termination process, and shuts off the power (step ST22) before ending the control routine. If the power switch 118 is not turned off, the program flow returns to step ST24 to wait for an input from either one of the operation switches 120 and 122 while maintaining the walking assistance control.

When the walking assistance control is to be terminated, the user presses at least one of the operation switches 120 and 122 (step ST 24), and this causes a walking assistance control process to be terminated (step ST 26). Following the termination of the walking assistance control, the ECU 108 waits for the communication from the PDA 140 (step ST27), and waits for a signal input from the operation switches 120 and 122 (step ST20) until a signal is received from the PDA 140.

When a signal is received from the PDA 140, the command from the operation switches 120 and 122 is thereafter disregarded (step ST28), and communication with the PDA 140 is executed (step ST29). Disregarding or canceling the command from the operation switches 120 and 122 during the communication with the PDA 140 enhances the safety of the walking assistance device.

As soon as the communication with the PDA 140 is completed, the command from the operation switches 120 and 122 are enabled (step ST30), and the ECU 108 waits for a command from the operation switches 120 and 122.

In the foregoing embodiment, the command from the operation switches 120 and 122 is enabled only when the identification code is successfully verified, and the control parameters are received, but it is also possible to enable the command from the operation switches 120 and 122 when only one of the two events has occurred.

The external device that may be used in conjunction with the walking assistance device of the present invention may consist of devices other than a PDA 140, and may consist of USB memory 148, SD card 150 or an IC card 154 storing the ID code and control parameters. The ECU 108 may read data from such a removable storage device via a memory interface unit 146 thereof, and may read data from an IC card 152 via an IC card reader (R/F reader) 152 connected to the ECU 108.

Although the present invention has been described in terms of a preferred embodiment thereof, it is obvious to a person skilled in the art that various alterations and modifications are possible without departing from the scope of the present invention which is set forth in the appended claims.

The contents of the original Japanese patent application on which the Paris Convention priority claim is made for the present application are incorporated in this application by reference.

1. A walking assistance device configured to apply a walking assistance force produced by an electric motor to a femoral part of a user, comprising:
a control unit for controlling an operation of the electric motor;
a power switch for selectively supplying electric power to the control unit;
an operation switch for forwarding a signal to the control unit to selectively drive the electric motor;
a communication unit for receiving a signal from an external device;
an operation switch enabling unit that disables the operation switch until the communication unit receives a signal from the external device even when the power switch is turned on, and enables the operation switch when the communication unit has received a signal from the external device while the power switch is turned on.

2. The walking assistance device according to claim 1, wherein the signal received from the external device by the communication unit includes control parameters for operating the walking assistance device, and the control unit is configured to set the control parameters therein.

3. The walking assistance device according to claim 2, wherein the control parameters are designated for each of a plurality of users.

4. The walking assistance device according to claim 1, wherein the signal received from the external device by the communication unit includes identification information unique to the particular walking assistance device, and the communication unit is configured to respond to the signal received from the external device only when the identification information matches with that of the particular walking assistance device.

5. The walking assistance device according to claim 1, wherein the communication unit comprises a wireless communication unit, and the external device comprises a terminal configured to establish a wireless communication link with the wireless communication unit.

6. The walking assistance device according to claim 1, wherein the communication unit comprises an interface unit, and the external device comprises a removable storage medium adapted to be interfaced by the interface unit.

7. The walking assistance device according to claim 1, wherein the communication unit comprises an IC card reader, and the external device comprises an IC card reader.
